(19) United States
(12) Patent Application Publication
(10) Pub. No.: US 2021/0060954 A1
(43) Pub. Date: Mar. 4, 2021

(54) LIQUID ABSORBER AND LIQUID EJECTION APPARATUS

(71) Applicant: SEIKO EPSON CORPORATION, Tokyo (JP)

(72) Inventors: Yoichi MIYASAKA, Suwa (JP); Naotaka HIGUCHI, Nagano (JP); Shogo NAKADA, Matsumoto (JP)

(21) Appl. No.: 17/002,839

(22) Filed: Aug. 26, 2020

(30) Foreign Application Priority Data
Aug. 28, 2019 (JP) 2019-155422

(51) Int. Cl. B41J 2/165

(52) U.S. Cl. CPC B41J 2/16517

(57) ABSTRACT

A liquid absorber includes a first liquid absorption member, a second liquid absorption member, and a case in which the first liquid absorption member and the second liquid absorption member are stored. The first liquid absorption member absorbs a portion of a liquid. The second liquid absorption member absorbs a portion of the liquid. A penetration property of the first liquid absorption member with respect to the liquid is greater than a penetration property of the second liquid absorption member with respect to the liquid. An absorption rate of the second liquid absorption member with respect to the liquid is greater than an absorption rate of the first liquid absorption member with respect to the liquid. When the liquid is introduced into the case, the liquid comes into contact with the first liquid absorption member before coming into contact with the second liquid absorption member.

The present application is based on, and claims priority from JP Application Serial Number 2019-155422, filed Aug. 28, 2019, the disclosure of which is hereby incorporated by reference herein in its entirety.

### BACKGROUND

### 1. Technical Field

The present disclosure relates to a liquid absorber and a liquid ejection apparatus.

### 2. Related Art

In ink jet printers, waste ink is typically generated during a head cleaning operation, which is performed to prevent a reduction in printing quality due to nozzle clogging caused by the drying of ink, and during an ink filling operation after a replacement of an ink cartridge. To absorb waste ink, a liquid absorber including a liquid absorption member is used.

JP-A-2005-119210, for example, states that when waste ink resulting from a high-viscosity ink is directly dropped onto an absorption member, only the liquid component is absorbed during an initial time period, and as a result, a waste ink solid adhesion layer is formed on a portion on which the waste ink falls. When a waste ink solid adhesion layer has been formed, the absorption member can no longer easily absorb waste ink.

As a solution to such a problem, JP-A-2005-119210 discloses an absorption member in which a cutout portion is provided to enable waste ink to reach the bottom surface of a case.

As stated in JP-A-2005-119210, in absorption members that absorb the liquid component during an initial time, waste ink cannot reach a bottom portion of the case because in such absorption members, a waste ink solid adhesion layer is formed at a location where the waste ink has been dropped. As a result, the absorption amount that is required cannot be ensured. Consequently, if the case falls over after waste ink has been introduced into the case, the waste ink may leak out of the case.

On the other hand, for example, using an absorption member having a low bulk density enables waste ink to reach a bottom portion of the case because such an absorption member has an increased penetration property with respect to waste ink. However, absorption members having a low bulk density have a low absorption rate with respect to waste ink. Accordingly, if the case falls over after waste ink has been introduced into the case, the waste ink may leak out of the case.

### SUMMARY

According to an aspect of the present disclosure, a liquid absorber includes a first liquid absorption member, a second liquid absorption member, and a case in which the first liquid absorption member and the second liquid absorption member are stored. The first liquid absorption member absorbs a portion of a liquid. The second liquid absorption member absorbs a portion of the liquid. A penetration property of the first liquid absorption member with respect to the liquid is greater than a penetration property of the second liquid absorption member with respect to the liquid. An absorption rate of the second liquid absorption member with respect to the liquid is greater than an absorption rate of the first liquid absorption member with respect to the liquid. When the liquid is introduced into the case, the liquid comes into contact with the first liquid absorption member before coming into contact with the second liquid absorption member.

According to another aspect, the liquid absorber may be as follows. A bulk density of the first liquid absorption member may be less than a bulk density of the second liquid absorption member.

According to another aspect, the liquid absorber may be as follows. The first liquid absorption member and the second liquid absorption member may be formed of small pieces, and the small pieces may include fiber substrates and a liquid-absorbent resin supported on the fiber substrates.

According to another aspect, the liquid absorber may be as follows. The first liquid absorption member may be formed of small pieces, and the small pieces may include fiber substrates and a liquid-absorbent resin supported on the fiber substrates. The second liquid absorption member may be a porous body.

According to another aspect, the liquid absorber may be as follows. The first liquid absorption member may be a porous body, and the second liquid absorption member may be a porous body.

According to another aspect, the liquid absorber may be as follows. The first liquid absorption member may be disposed on the second liquid absorption member. An inlet through which the liquid is to be introduced into the case may be disposed in an upper portion of the case.

According to another aspect, the liquid absorber may be as follows. The second liquid absorption member may be disposed on the first liquid absorption member. An inlet through which the liquid is to be introduced into the case may be disposed in an upper portion of the case. In the second liquid absorption member, a cutout or a cavity may be disposed in a position corresponding to the inlet.

According to another aspect, the liquid absorber may be as follows. The second liquid absorption member may be disposed on the first liquid absorption member. An inlet through which the liquid is to be introduced into the case may be disposed in a sidewall portion of the case. The inlet may be disposed adjacent to a side of the first liquid absorption member.

According to an aspect of the present disclosure, a liquid ejection apparatus includes a liquid ejection head and the liquid absorber according to any of the aspects described above. The liquid absorber is an absorber that absorbs the liquid. The liquid is ejected from the liquid ejection head.

### BRIEF DESCRIPTION OF THE DRAWINGS

FIG. 1 is a schematic cross-sectional view of a liquid absorber according to an embodiment of the present disclosure.

FIG. 2 is a schematic diagram of a first liquid absorption member of the liquid absorber according to the embodiment.

FIG. 3 is a schematic perspective view of a small piece included in the liquid absorber, according to the embodiment.

FIG. 4 is a schematic cross-sectional view of a small piece included in the liquid absorber, according to the embodiment.

FIG. 5 is a diagram illustrating a method for producing the liquid absorber, according to the embodiment.

FIG. 6 is a diagram illustrating the method for producing the liquid absorber, according to the embodiment.

FIG. 7 is a diagram illustrating the method for producing the liquid absorber, according to the embodiment.

FIG. 8 is a schematic plan view of a liquid absorber according to a first modified example of the embodiment.

FIG. 9 is a schematic cross-sectional view of the liquid absorber according to the first modified example of the embodiment.

FIG. 10 is a schematic plan view of the liquid absorber according to the first modified example of the embodiment.

FIG. 11 is a schematic cross-sectional view of a liquid absorber according to a second modified example of the embodiment.

FIG. 12 is a schematic cross-sectional view of a small piece included in a liquid absorber, according to a third modified example of the embodiment.

FIG. 13 is a diagram illustrating a method for producing the liquid absorber, according to the third modified example of the embodiment.

FIG. 14 is a diagram illustrating the method for producing the liquid absorber, according to the third modified example of the embodiment.

FIG. 15 is a schematic cross-sectional view of a liquid absorber according to a fourth modified example of the embodiment.

FIG. 16 is a schematic diagram of a liquid ejection apparatus according to an embodiment of the present disclosure.

FIG. 17 is a table showing the evaluation results of Examples 1 to 6 and Comparative Examples 1 to 3.

### DESCRIPTION OF EXEMPLARY EMBODIMENTS

Preferred embodiments of the present disclosure will now be described in detail with reference to the drawings. Note that the embodiments described below are not intended to unduly limit the content of the present disclosure described in the claims. Furthermore, not all of the configurations described below may be essential configuration requirements of the present disclosure.

### 1. Liquid Absorber

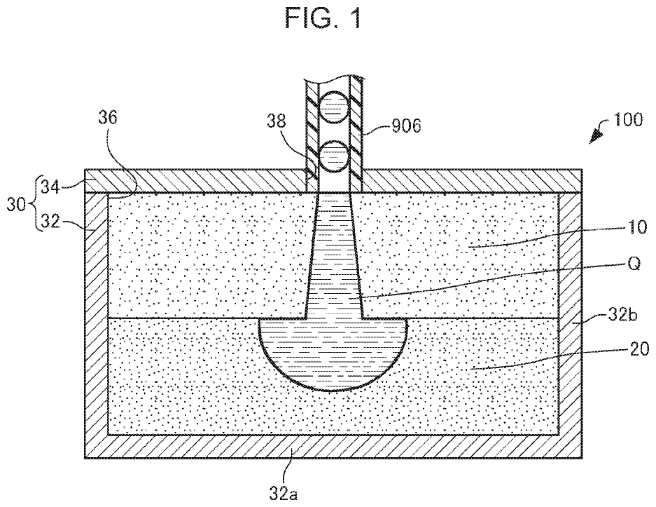

First, a liquid absorber according to an embodiment of the present disclosure will be described with reference to the drawings. FIG. 1 is a schematic cross-sectional view of a liquid absorber 100, according to an embodiment of the present disclosure.

As illustrated in FIG. 1, the liquid absorber 100 includes a first liquid absorption member 10, a second liquid absorption member 20, and a case 30. In the following description, each of the elements will be described.

### 1. 1. First Liquid Absorption Member

The first liquid absorption member 10 absorbs liquid. Specifically, the first liquid absorption member 10 absorbs inks, such as an aqueous ink in which a colorant is dissolved in an aqueous solvent, a solvent-based ink in which a binder is dissolved in a solvent, a UV (ultraviolet) curable ink in which a binder is dissolved in a liquid monomer and which is cured by UV irradiation, and a latex ink in which a binder is dispersed in a dispersion medium. The first liquid absorption member 10 absorbs inks including a pigment. The following description is made assuming that the liquid absorbed by the first liquid absorption member 10 is an ink Q.

### 1. 1. 1. Small Pieces

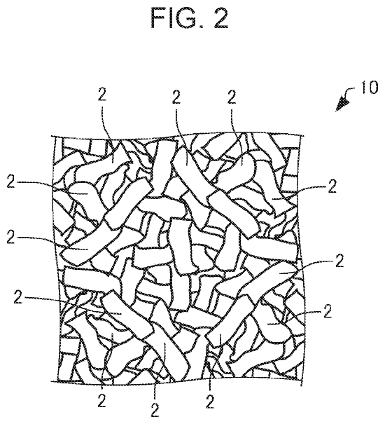

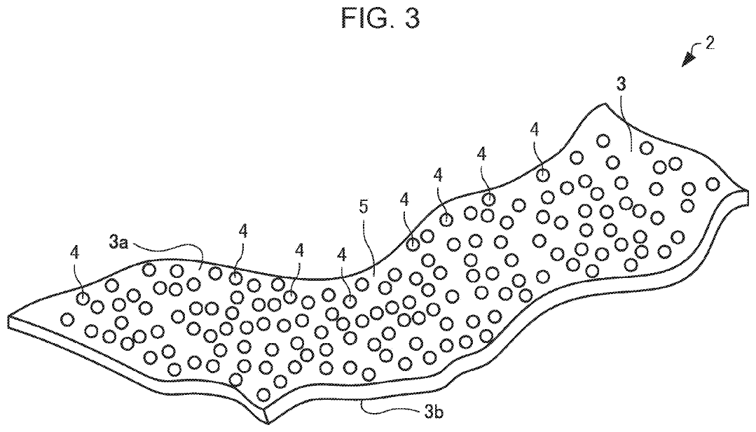

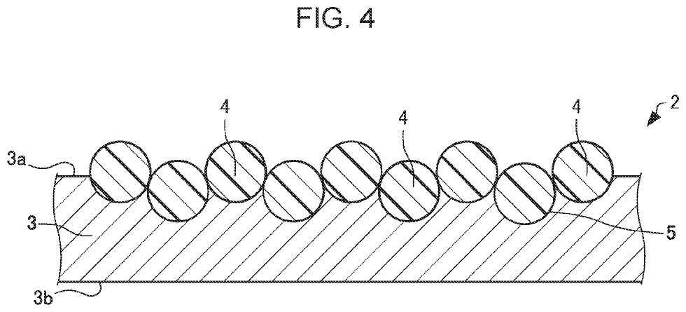

FIG. 2 is a schematic diagram of the first liquid absorption member 10. As illustrated in FIG. 2, the first liquid absorption member 10 includes, for example, an assembly of small pieces 2. The first liquid absorption member 10 may be formed of small pieces 2. FIG. 3 is a schematic perspective view of a small piece 2. FIG. 4 is a schematic cross-sectional view of a small piece 2.

As illustrated in FIG. 3 and FIG. 4, the small piece 2 includes, for example, a fiber substrate 3 and a liquid-absorbent resin 4, which is supported on the fiber substrate 3. Note that although not illustrated, the small piece 2 may not include the liquid-absorbent resin 4 and may be formed of the fiber substrate 3.

It is preferable that the small pieces 2 be strip-shaped pieces having flexibility. With this configuration, the small pieces 2 can be easily deformed. Hence, when the first liquid absorption member 10 is stored in the case 30, the first liquid absorption member 10 is deformed regardless of the shape of the case 30 and, therefore, can be stored therein without difficulty.

A full length of the small pieces 2, that is, a length in a longitudinal direction of the small pieces 2, is preferably 0.5 mm or greater and 200 mm or less, more preferably 1 mm or greater and 100 mm or less, and even more preferably 3 mm or greater and 30 mm or less.

A width of the small pieces 2, that is, a length in a transverse direction of the small pieces 2, is preferably 0.1 mm or greater and 100 mm or less, more preferably 0.3 mm or greater and 50 mm or less, and even more preferably 1 mm or greater and 10 mm or less.

A thickness of the small pieces 2 is preferably 0.1 mm or greater and 20 mm or less and more preferably 1 mm or greater and 10 mm or less.

An aspect ratio between the full length of the small pieces 2 and the width thereof is preferably 1 or greater and 200 or less and more preferably 1 or greater and 30 or less.

For example, the small pieces 2 are stored in the case 30 randomly, without regularity, in a manner such that the longitudinal directions of the small pieces 2 do not extend parallel to one another but extend crosswise to one another. Thus, gaps can be easily formed between the small pieces 2. As a result, the ink Q can flow through the gaps, and, when the gaps are very small, ink can wet and spread under capillary action. Accordingly, the flowability of the ink Q is ensured. Hence, in the case 30, the ink Q flowing downwardly is prevented from being blocked along the way, and as a result, the ink Q can penetrate to the second liquid absorption member 20.

A bulk density of the first liquid absorption member 10 is preferably 0.01 g/cm³ or greater and 0.50 g/cm³ or less, more preferably 0.03 g/cm³ or greater and 0.30 g/cm³ or less, and even more preferably 0.05 g/cm³ or greater and 0.20 g/cm³ or less.

### 1. 1. 2. Fiber Substrate

The fiber substrate 3 has a sheet shape. The fiber substrate 3 includes fibers. The first liquid absorption member 10 includes an assembly of fiber substrates 3. In the illustrated example, the first liquid absorption member 10 includes an assembly of the fiber substrates 3, on which the liquid-absorbent resin 4 is supported.

Examples of the fiber that is included in the fiber substrate 3 include synthetic resin fibers, such as polyester fibers and polyethylene fibers, and natural resin fibers, such as cellulose fibers, keratinous fibers, and fibroin fibers.

It is preferable that the fiber included in the fiber substrate 3 be a cellulose fiber. Cellulose fibers are hydrophilic materials, and, therefore, when ink is provided to a cellulose fiber, the cellulose fiber can suitably take in the ink. In addition, the cellulose fiber can suitably deliver the ink that is taken temporarily to the liquid-absorbent resin 4. Hence, the first liquid absorption member 10 has excellent absorption characteristics with respect to ink. Furthermore, cellulose fibers have a high affinity for the liquid-absorbent resin 4, and, therefore, a cellulose fiber can suitably support the liquid-absorbent resin 4 on a surface of the fiber. Furthermore, cellulose fibers are renewable natural materials and are inexpensive and readily available compared with various other fibers. As such, cellulose fibers are advantageous also from the standpoint of reducing the production cost, ensuring stable production, and reducing environmental impact, for example.

Note that it is sufficient that the cellulose fiber be a fibrous material containing, as a major component, cellulose included in a compound, and the compound may include hemicellulose and/or lignin in addition to cellulose.

An average length of the individual fibers is preferably 0.1 mm or greater and 7 mm or less, more preferably 0.1 mm or greater and 5 mm or less, and even more preferably 0.1 mm or greater and 3 mm or less. An average width of the individual fibers is preferably 0.5 μm or greater and 200 μm or less and more preferably 1.0 gm or greater and 100 μm or less. An average aspect ratio of the individual fibers is preferably 10 or greater and 1000 or less and more preferably 15 or greater and 500 or less. The average aspect ratio is the ratio of the average length to the average width.

When the above-mentioned ranges are satisfied, the liquid-absorbent resin 4 can be more suitably supported, the ink Q can be more suitably held in the fiber, and the ink Q can be more suitably delivered to the liquid-absorbent resin 4.

### 1. 1. 3. Liquid-Absorbent Resin

As illustrated in FIG. 3 and FIG. 4, the particles of the liquid-absorbent resin 4 are supported on the fiber substrate 3. In the illustrated example, the particles of the liquid-absorbent resin 4 are supported only on one surface 3a of the fiber substrate 3. Although not illustrated, some or all of the particles of the liquid-absorbent resin 4 may be supported on another surface 3b of the fiber substrate 3. The particles of the liquid-absorbent resin 4 are bonded to and supported on the fiber substrates 3 with water.

As illustrated in FIG. 4, the particles of the liquid-absorbent resin 4 may be partially embedded in the one surface 3a of the fiber substrate 3. That is, the particles of the liquid-absorbent resin 4 may be partially enclosed in the fiber substrate 3. With this configuration, the ability of the fiber substrate 3 to support the liquid-absorbent resin 4 is increased. Hence, the liquid-absorbent resin 4 is prevented from falling off the fiber substrate 3. In addition, uneven distribution of the liquid-absorbent resin 4 in the case 30 is prevented.

Note that the particles of the liquid-absorbent resin 4 may not be partially embedded in the surface 3a of the fiber substrate 3. The particles of the liquid-absorbent resin 4 may be merely applied to the fiber substrate 3 and thus may merely adhere to the fiber substrate 3.

The liquid-absorbent resin 4 is a super absorbent polymer (SAP) having liquid absorbency properties. The term “liquid absorbency” refers to the ability to exhibit hydrophilicity and retain a liquid component. The liquid-absorbent resin 4 may be gelled as a result of absorption of liquid. Specifically, the liquid-absorbent resin 4 absorbs liquid present in ink, such as water and a hydrophilic organic solvent.

Examples of the liquid-absorbent resin 4 include carboxymethyl cellulose, polyacrylic acids, polyacrylamides, starch-acrylic acid graft copolymers, hydrolysates of starch-acrylonitrile graft copolymers, vinyl acetate-acrylic ester copolymers, isobutylene-maleic acid copolymers, hydrolysates of acrylonitrile copolymers or acrylamide copolymers, polyethylene oxide, polysulfonic acid compounds, polyglutamic acids, salts thereof, modified products thereof, and crosslinked products thereof.

It is preferable that the liquid-absorbent resin 4 be a resin including structural units that contain a functional group in a side chain. Examples of the functional group include acid groups, hydroxyl groups, epoxy groups, and amino groups. In particular, it is preferable that an acid group be present in the side chain of the resin, and it is more preferable that a carboxyl group be present in the side chain of the resin.

Examples of a carboxyl-group-containing unit that may be included in the side chain include units derived from a monomer such as acrylic acid, methacrylic acid, itaconic acid, maleic acid, crotonic acid, fumaric acid, sorbic acid, cinnamic acid, an anhydride of any of the foregoing acids, or a salt of any of the foregoing acids.

When the liquid-absorbent resin 4 is a resin including structural units that contain an acid group in a side chain, a percentage of acid groups of the liquid-absorbent resin 4 that are neutralized and form a salt, relative to the total moles of acid groups in the liquid-absorbent resin 4, is preferably 30 mol % or greater and 100 mol % or less, more preferably 50 mol % or greater and 95 mol % or less, even more preferably 60 mol % or greater and 90 mol % or less, and most preferably 70 mol % or greater and 80 mol % or less. Such a liquid-absorbent resin 4 has excellent absorption characteristics with respect to the ink Q.

Examples of the neutralized salt include alkali metal salts, such as sodium salts, potassium salts, and lithium salts, and salts of a nitrogen-containing basic compound, such as ammonia. In particular, a sodium salt is preferable. Such a liquid-absorbent resin 4 has excellent absorption characteristics with respect to the ink Q.

In a liquid-absorbent resin 4 including structural units that contain an acid group in a side chain, electrostatic repulsion occurs between acid groups during absorption of ink, which increases the absorption rate. Thus, such a liquid-absorbent resin 4 is preferable. Furthermore, in the instance in which acid groups are neutralized, the ink Q can be easily absorbed into the liquid-absorbent resin 4 under osmotic pressure.

The liquid-absorbent resin 4 may have a structural unit in which no acid group is present in a side chain. Examples of such a structural unit include hydrophilic structural units, hydrophobic structural units, and structural units that serve as a polymerizable crosslinking agent.

Examples of the hydrophilic structural units include structural units derived from a nonionic compound, such as acrylamide, methacrylamide, N-ethyl (meth)acrylamide, N-n-propyl (meth) acrylamide, N-isopropyl (meth) acrylamide, N,N-dimethyl (meth) acrylamide, 2-hydroxyethyl (meth)acrylate, 2-hydroxypropyl (meth) acrylate, methoxypolyethylene glycol (meth)acrylate, polyethylene glycol mono(meth)acrylate, N-vinylpyrrolidone, N-acryloylpiperidine, or N-acryloylpyrrolidine.

Examples of the hydrophobic structural units include structural units derived from a compound such as (meth)acrylonitrile, styrene, vinyl chloride, butadiene, isobutene, ethylene, propylene, stearyl (meth)acrylate, or lauryl (meth) acrylate.

Examples of the structural units that serve as a polymerizable crosslinking agent include structural units derived from a compound such as diethyleneglycol diacrylate, N,N-methylenebisacrylamide, polyethylene glycol diacrylate, polypropylene glycol diacrylate, trimethylolpropane diallyl ether, trimethylolpropane triacrylate, allyl glycidyl ether, pentaerythritol triallyl ether, pentaerythritol diacrylate monostearate, bisphenol diacrylate, isocyanurate diacrylate, tetraallyloxyethane, or a salt of diallyloxyacetic acid.

It is preferable that the liquid-absorbent resin 4 include a polyacrylic acid salt copolymer or a crosslinked polyacrylic acid polymer. Such a liquid-absorbent resin 4 exhibits improved ink absorption performance and enables a reduction in production cost, for example.

In the crosslinked polyacrylic acid polymer, a percentage of carboxyl-group-containing structural units relative to the total moles of all the structural units included in the molecular chain is preferably greater than or equal to 50 mol %, more preferably greater than or equal to 80 mol %, and even more preferably greater than or equal to 90 mol %. If the percentage of the carboxyl-group-containing structural units is too low, it may be difficult to ensure a sufficiently good absorption characteristic with respect to the ink Q.

It is preferable that some of the carboxyl groups in the crosslinked polyacrylic acid polymer be neutralized and form a salt. In the crosslinked polyacrylic acid polymer, a percentage of neutralized carboxyl groups relative to the total moles of all the carboxyl groups is preferably 30 mol % or greater and 99 mol % or less, more preferably 50 mol % or greater and 99 mol % or less, and even more preferably 70 mol % or greater and 99 mol % or less.

The liquid-absorbent resin 4 may include a crosslinked structure formed with a crosslinking agent other than the polymerizable crosslinking agent mentioned above.

When the liquid-absorbent resin 4 is a resin containing acid groups, it is preferable that the crosslinking agent be, for example, a compound containing acid groups and functional groups that are reactive with acid groups. When the liquid-absorbent resin 4 is a resin containing acid groups and functional groups that are reactive with acid groups, it is preferable that the crosslinking agent be a compound containing, in the molecule, functional groups that are reactive with acid groups.

Examples of the crosslinking agent containing acid groups and functional groups that are reactive with acid groups include glycidyl ether compounds, such as ethylene glycol diglycidyl ether, trimethylolpropane triglycidyl ether, (poly)glycerol polyglycidyl ether, diglycerol polyglycidyl ether, and propylene glycol diglycidyl ether; polyhydric alcohols, such as (poly)glycerol, (poly)ethylene glycol, propylene glycol, 1,3-propanediol, polyoxyethylene glycol, triethylene glycol, tetraethylene glycol, diethanolamine, and triethanolamine; and polyamines and the like, such as ethylenediamine, diethylenediamine, polyethyleneimine, and hexamethylene diamine. Other preferred examples include ions of a multivalent metal, such as zinc, calcium, magnesium, or aluminum. Such ions serve as a crosslinking agent by reacting with acid groups present in the liquid-absorbent resin 4.

The particles of the liquid-absorbent resin 4 may have any shape, such as flaky, acicular, fibrous, or substantially spherical or equiaxed, but it is preferable that most of the particles have a substantially spherical or equiaxed shape. When most of the particles of the liquid-absorbent resin 4 have a substantially spherical or equiaxed shape, a penetration property with respect to the ink Q can be easily ensured. In addition, the liquid-absorbent resin 4 can be suitably supported on the fiber. Note that the phrase “substantially spherical or equiaxed shape” refers to a shape having an aspect ratio of 0.3 or greater and 1.0 or less. The aspect ratio is the ratio of a minimum length of the particle to a maximum length thereof. An average particle diameter of the particles is preferably 15 μm or greater and 800 μm or less, more preferably 15 μm or greater and 400 μm or less, and even more preferably 15 μm or greater and 50 μm or less.

Note that the average particle diameter of the particles may be, for example, a mean volume diameter MVD, which is a volume-based mean particle diameter measured with a laser diffraction particle diameter distribution analyzer. Particle diameter distribution analyzers using the laser diffraction light scattering method as the measurement principle, that is, laser diffraction particle diameter distribution analyzers, can measure particle diameter distributions based on volume.

Preferably, a relationship of 0.15≤L/D≤467 is satisfied, more preferably, a relationship of 0.25≤L/D≤333 is satisfied, and even more preferably, a relationship of 2≤L/D≤200 is satisfied, where D is the average particle diameter [μm] of the liquid-absorbent resin 4, and L is the average length [μm] of the individual fibers.

In the liquid absorption member 10, a content of the liquid-absorbent resin 4 is preferably 25 mass % or greater and 300 mass % or less and more preferably 50 mass % or greater and 150 mass % or less, relative to a mass of the fiber.

### 1. 1. 4. Adhesive

As described in the above section, “1. 1. 3. Liquid-Absorbent Resin”, the liquid-absorbent resin 4 is bonded to and supported on the fiber substrates 3 with water. In addition, the small pieces 2 may include an adhesive 5, which bonds the liquid-absorbent resin 4 to the fiber substrates 3. Accordingly, the ability of the fiber substrates 3 to support the liquid-absorbent resin 4 is enhanced, which makes it unlikely that the liquid-absorbent resin 4 will fall off the fiber substrates 3. Note that the small pieces 2 may not include the adhesive 5.

Examples of the adhesive 5 include water-soluble adhesives and organic adhesives. In particular, a water-soluble adhesive is preferable. In instances in which the ink Q is an aqueous ink, even if a water-soluble adhesive adheres to a surface of the liquid-absorbent resin 4, the water-soluble adhesive dissolves when the ink Q comes into contact with the water-soluble adhesive. Thus, the adhesive 5 is prevented from interfering with the absorption of the ink Q into the liquid-absorbent resin 4.

Example of the adhesive 5 include proteins, such as casein, soy protein, and synthetic protein; various starches, such as starch and oxidized starch; polyvinyl alcohols, which include polyvinyl alcohol and modified polyvinyl alcohols, such as cationic polyvinyl alcohols and silyl-modified polyvinyl alcohols; cellulose derivatives, such as carboxymethyl cellulose and methylcellulose; aqueous polyurethane resins; and aqueous polyester resins. In particular, a polyvinyl alcohol is preferable in terms of bonding force. With a polyvinyl alcohol, the bonding force between the fiber substrate 3 and the liquid-absorbent resin 4 is sufficiently enhanced.

In the liquid absorption member 10, a content of the adhesive 5 is preferably 1.0 mass % or greater and 70 mass % or less and more preferably 2.5 mass % or greater and 50 mass % or less, relative to the mass of the fiber. If the content of the adhesive 5 is less than 1.0 mass % relative to the mass of the fiber, it is impossible to sufficiently produce an effect of the presence of the adhesive 5. On the other hand, if the content of the adhesive 5 is too high, no further significant improvement in the ability to support the liquid-absorbent resin 4 can be achieved.

Note that the liquid absorption member 10 may include one or more of the following, for example: a surfactant, a lubricant, a defoamer, a filler, an anti-blocking agent, a UV absorber, a colorant, such as a pigment or a dye, a flame-retardant agent, and a flow improver.

### 1. 2. Second Liquid Absorption Member

Similarly to the first liquid absorption member 10, the second liquid absorption member 20 absorbs the ink Q. For example, similarly to the first liquid absorption member 10, the second liquid absorption member 20 is formed of small pieces 2, which include fiber substrates 3 and a liquid-absorbent resin 4, which is supported on the fiber substrates 3. The description of the small pieces 2 of the first liquid absorption member 10 described above can be applied to the small pieces 2 of the second liquid absorption member 20.

1. 3. Comparison between First Liquid Absorption Member and Second Liquid Absorption Member

A bulk density of the first liquid absorption member 10 is less than a bulk density of the second liquid absorption member 20. Note that the “bulk density” is a loose bulk density and is a value determined as follows: a container of a known volume is filled with a liquid absorption member, and the mass of the liquid absorption member within the container is divided by the volume of the container.

An area of the small pieces 2 of the first liquid absorption member 10 is larger than an area of the small pieces 2 of the second liquid absorption member 20. Note that the “area of the small pieces 2” is an area of the small pieces 2 as viewed in a thickness direction of the small pieces 2 in a state in which the small pieces 2 have been pulled with a degree of force that does not tear the small pieces 2 and thus stretched.

A penetration property of the first liquid absorption member 10 with respect to the ink Q is greater than a penetration property of the second liquid absorption member 20 with respect to the ink Q. The penetration properties are compared in the following manner, for example: a predetermined volume of each of the liquid absorption members is placed in a container having an open upper end, and the container is vibrated, and thereafter, a predetermined amount of the ink Q is added dropwise to the liquid absorption member from an upper position to measure the time that elapses before the ink Q reaches the bottom surface of the container.

An absorption rate of the second liquid absorption member 20 with respect to the ink Q is greater than an absorption rate of the first liquid absorption member 10 with respect to the ink Q. The absorption rates are compared in the following manner, for example: a predetermined volume of each of the liquid absorption members is placed in a container having an open upper end, and the container is vibrated, and thereafter, a predetermined amount of the ink Q is added dropwise to the liquid absorption member from an upper position, and then the container is turned on its side to measure the time that elapses before the ink Q starts leaking out of the container.

As illustrated in FIG. 1, the first liquid absorption member 10 is disposed on the second liquid absorption member 20. In the illustrated example, the first liquid absorption member 10 is disposed between the second liquid absorption member 20 and a cover 34 of the case 30. When the ink Q is introduced into the case 30, the ink Q comes into contact with the first liquid absorption member 10 before coming into contact with the second liquid absorption member 20. After coming into contact with the first liquid absorption member 10, the ink Q passes through the first liquid absorption member 10 and comes into contact with the second liquid absorption member 20.

### 1. 4. Case

The first liquid absorption member 10 and the second liquid absorption member 20 are stored in the case 30. The case 30 has a rectangular parallelepiped shape, for example. In the illustrated example, the case 30 includes a body 32 and the cover 34.

For example, the body 32 includes a bottom portion 32a, which has a quadrilateral plan-view shape, and the four sidewall portions 32b, which are disposed along the respective sides of the bottom portion 32a. The body 32 has a shape in which an opening 36 is disposed in an upper portion. Note that the plan-view shape of the bottom portion 32a is not limited to a quadrilateral shape and may be, for example, a circular shape.

It is preferable that the body 32 have a degree of shape retainability such that a volume of the body 32 does not change by 10% or greater when an internal pressure or an external force acts on the body 32. With such a degree of shape retainability, the body 32 can maintain its shape even when the liquid absorption members 10 and 20 absorb the ink Q and swell and thereby causes the body 32 to receive a force from the liquid absorption members 10 and 20. As a result, the installation state of the body 32 is stabilized, and, consequently, the liquid absorption members 10 and 20 can absorb the ink Q in a consistent manner. For example, a material of the body 32 is a resin material, such as a cyclic polyolefin or a polycarbonate, or a metal material, such as aluminum or stainless steel.

The cover 34 is coupled to the body 32. The cover 34 closes the opening 36 of the body 32. The cover 34 has a plate shape, for example. A thickness of the cover 34 is preferably 1 mm or greater and 20 mm or less and more preferably 8 mm or greater and 10 mm or less. Note that the cover 34 is not limited to a plate-shaped cover that satisfies a numerical range such as those mentioned above, and the cover 34 may be a film-shaped cover having a smaller thickness. In such a configuration, the thickness of the cover 34 is preferably 10 μm or greater and less than 1 mm.

An inlet 38, through which the ink Q is to be introduced into the case 30, is disposed in the case 30. The inlet 38 is disposed in an upper portion of the case 30. In the illustrated example, the inlet 38 is disposed in the cover 34. The inlet 38 extends through the cover 34. When the ink Q is to be discharged to the liquid absorber 100, an inlet tube 906 is inserted into the inlet 38 to discharge the ink Q through the inlet tube 906.

Note that although not illustrated, a rib may be disposed on an inner surface of the case 30, the rib protruding from the inner surface. This configuration inhibits mixing of the small pieces 2 of the first liquid absorption member 10 with the small pieces 2 of the second liquid absorption member 20.

Furthermore, the first liquid absorption member 10 and the second liquid absorption member 20 may be bonded to the inner surface of the case 30. This configuration inhibits mixing of the small pieces 2 of the first liquid absorption member 10 with the small pieces 2 of the second liquid absorption member 20.

### 1. 5. Effects

The liquid absorber 100 has the following effects, for example.

In the liquid absorber 100, the penetration property of the first liquid absorption member 10 with respect to the ink Q is greater than the penetration property of the second liquid absorption member 20 with respect to the ink Q; the absorption rate of the second liquid absorption member 20 with respect to the ink Q is greater than the absorption rate of the first liquid absorption member 10 with respect to the ink Q; and, when the ink Q is introduced into the case 30, the ink Q comes into contact with the first liquid absorption member 10 before coming into contact with the second liquid absorption member 20.

As described above, in the liquid absorber 100, the penetration property of the first liquid absorption member 10, with which the ink Q comes into contact first, is greater than the penetration property of the second liquid absorption member 20, and, therefore, it is unlikely that an ink Q solid adhesion layer will be formed at a location where the ink Q has been dropped. Accordingly, the ink Q can pass through the first liquid absorption member 10 and come into contact with the second liquid absorption member 20, and, therefore, the ink Q can easily reach the entirety of the liquid absorption members 10 and 20. In addition, in the liquid absorber 100, the absorption rate with respect to the ink Q is greater in the second liquid absorption member 20 than in the first liquid absorption member 10, and, therefore, the ink Q can be sufficiently held in the second liquid absorption member 20. Hence, in the liquid absorber 100, even when the case 30 is turned on its side, it is unlikely that the ink Q will leak out of the case 30.

Even if an ink Q solid adhesion layer is formed on a surface of the first liquid absorption member 10, the ink Q can easily reach the entirety of the liquid absorption members 10 and 20 because a distance to the bottom portion 32a of the case 30 from a surface of the second liquid absorption member 20 is less than that from a surface of the first liquid absorption member 10. In addition, the surface of the first liquid absorption member 10 is less likely to dry than the surface of the second liquid absorption member 20, and, therefore, it is unlikely that an ink Q solid adhesion layer will be formed on the surface of the first liquid absorption member 10.

In the liquid absorber 100, the bulk density of the first liquid absorption member 10 is less than the bulk density of the second liquid absorption member 20. As a result, in the liquid absorber 100, the penetration property of the first liquid absorption member 10 with respect to the ink Q is greater than the penetration property of the second liquid absorption member 20 with respect to the ink Q. In addition, the absorption rate of the second liquid absorption member 20 with respect to the ink Q is greater than the absorption rate of the first liquid absorption member 10 with respect to the ink Q.

In the liquid absorber 100, the first liquid absorption member 10 and the second liquid absorption member 20 are formed of the small pieces 2. The small pieces 2 include the fiber substrates 3 and the liquid-absorbent resin 4 supported on the fiber substrates 3. Accordingly, in the liquid absorber 100, the liquid absorption members 10 and 20 have improved conformability to the shape of the case 30. As a result, the liquid absorption members 10 and 20 are highly versatile, and the production cost can be reduced.

The liquid-absorbent resin 4 absorbs the ink Q and swells. If the ink Q comes into contact with the second liquid absorption member 20 before coming into contact with the first liquid absorption member 10, the liquid-absorbent resin 4 begins to swell at a location where the ink Q has been dropped because the penetration property of the second liquid absorption member 20 is less than the penetration property of the first liquid absorption member 10. If this occurs, the penetration of the ink Q is blocked by the liquid-absorbent resin 4 that has swollen at the dropping location, and as a result, it becomes difficult for the ink Q to reach the entirety of the liquid absorption members 10 and 20. In the liquid absorber 100, since the ink Q comes into contact with the first liquid absorption member 10 before coming into contact with the second liquid absorption member 20, problems such as that described above can be avoided.

In the liquid absorber 100, the first liquid absorption member 10 is disposed on the second liquid absorption member 20, and the inlet 38, through which the ink Q is to be introduced into the case 30, is disposed in an upper portion of the case 30. This configuration of the liquid absorber 100 enables the ink Q to come into contact with the first liquid absorption member 10 before coming into contact with the second liquid absorption member 20.

### 2. Method for Producing Liquid Absorber

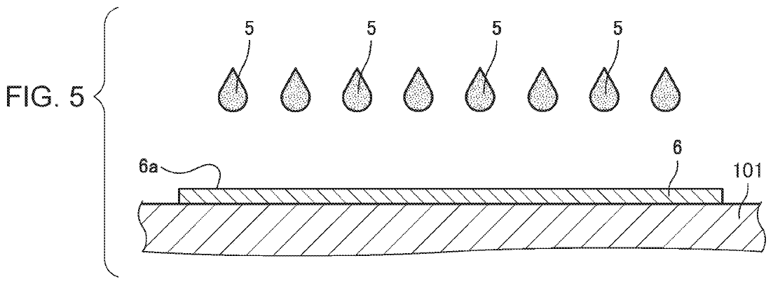

A method for producing the liquid absorber 100, according to the embodiment, will now be described with reference to the drawings. FIG. 5 to FIG. 7 are diagrams illustrating the method for producing the liquid absorber 100, according to the embodiment.

As illustrated in FIG. 5, a sheet-shaped sheet member 6 is laid on a bench 101. Examples of the sheet member 6 include waste paper.

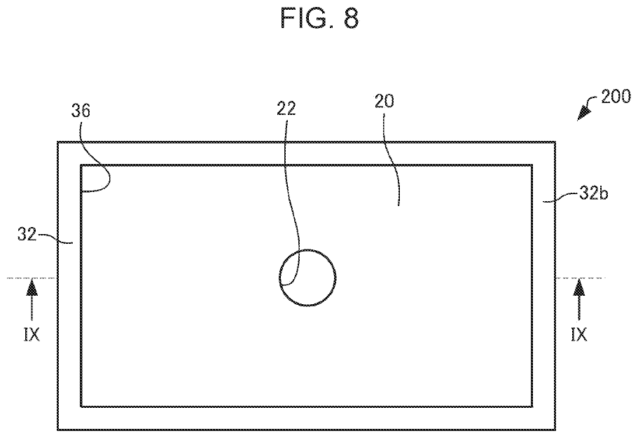

Next, water is applied to the sheet member 6 to bond the liquid-absorbent resin 4 to the sheet member 6. In addition, as illustrated in FIG. 8, an adhesive 5, which is in a liquid form, may be applied to one surface 6a. Examples of a method for applying the adhesive 5 include a spray method and a method in which a sponge roller is impregnated with the adhesive 5, and the sponge roller is rolled across the surface 6a of the sheet member 6.

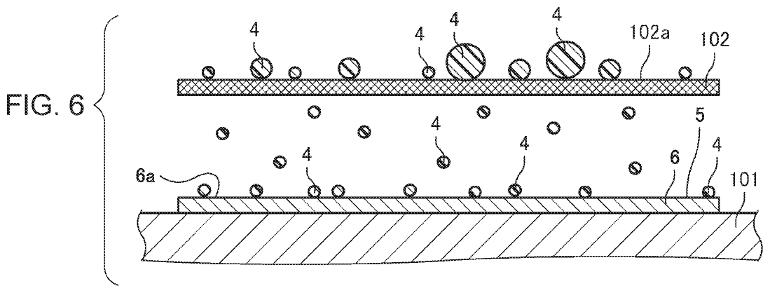

As illustrated in FIG. 6, particles of the liquid-absorbent resin 4 are applied to the surface 6a of the sheet member 6 through a mesh member 102. The mesh member 102 has openings 102a. Among the particles of the liquid-absorbent resin 4, particles larger than the openings 102a are retained on the mesh member 102, and particles smaller than the opening 102a pass through the openings 102a and are applied to the surface 6a of the sheet member 6.

Thus, the use of the mesh member 102 increases the uniformity of the particle diameters of the liquid-absorbent resin 4. Hence, variations in the absorption characteristics are prevented from occurring in different locations of the sheet member 6.

A maximum width of the openings 102a is preferably 0.06 mm or greater and 0.15 mm or less and more preferably 0.08 mm or greater and 0.12 mm or less. With this configuration, the particle diameters of the liquid-absorbent resin 4 applied to the sheet member 6 fall within the numerical range mentioned above.

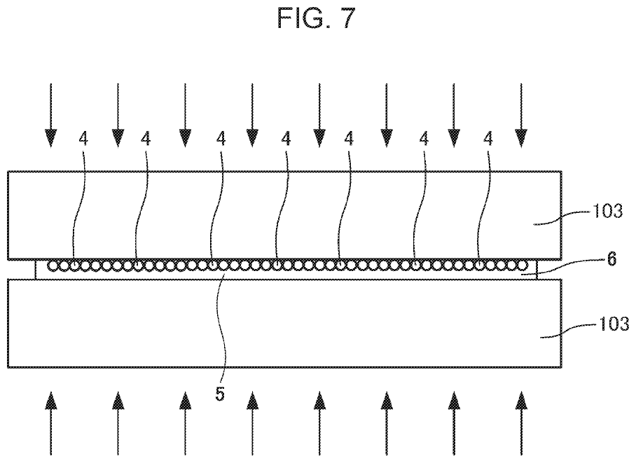

As illustrated in FIG. 7, the sheet member 6, to which the particles of the liquid-absorbent resin 4 adhere, is positioned between a pair of heating blocks 103. Subsequently, the pair of heating blocks 103 is heated, and pressure is applied to the pair of heating blocks 103 in a direction in which a distance between the heating blocks 103 decreases, thereby applying pressure to the sheet member 6 in a thickness direction thereof. Accordingly, the particles of the liquid-absorbent resin 4 and the adhesive 5 are softened, and the particles of the liquid-absorbent resin 4 become embedded in the sheet member 6 as a result of the application of pressure. Subsequently, the heating and pressure application are discontinued, and, accordingly, the adhesive 5 dries, and bonding is accomplished in a state in which the particles of the liquid-absorbent resin 4 are embedded in the sheet member 6.

In this step, the force of the pressure is preferably 0.1 kg/cm² or greater and 1.0 kg/cm² or less and more preferably 0.2 kg/cm² or greater and 0.8 kg/cm² or less. In this step, the heating temperature is preferably 80° C. or higher and 160° C. or lower and more preferably 100° C. or higher and 120° C. or lower.

Next, for example, the sheet member 6 is finely cut, crushed, or ground with scissors, a cutter, a mill, a shredder, or the like or, for example, finely torn by hand, to form small pieces 2. Next, a desired amount of the small pieces 2 are weighed out. Thereafter, the small pieces 2 are, for instance, loosened up by hand and stored in the body 32. In this manner, the second liquid absorption member 20 made up of the small pieces 2 can be formed.

Next, for example, the sheet member 6 is, for instance, cut to form small pieces 2 having a larger area than the small pieces 2 of the second liquid absorption member 20, and then the small pieces 2 are stored in the body 32. In this manner, the first liquid absorption member 10 that has a lower bulk density than the second liquid absorption member 20 can be formed.

Next, as illustrated in FIG. 1, the opening 36 of the body 32 is sealed with the cover 34. Specifically, the opening 36 of the body 32 is sealed with the cover 34 by using any of the following methods, for example: a method in which the cover 34 is a plastic molded article and is fitted to the body 32; a method in which the cover 34 is a film and is fused to the body 32; and a method in which the cover 34 is a mesh member and is fused to the body 32.

With the steps described above, the liquid absorber 100 can be produced.

### 3. Modified Examples of Liquid Absorber

### 3. 1. First Modified Example

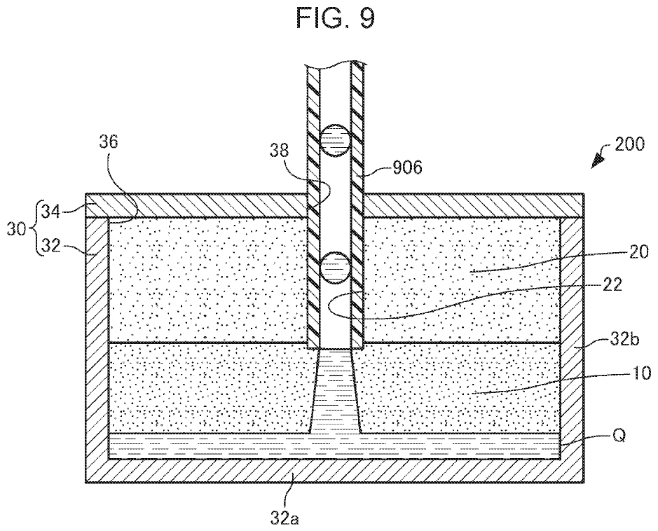

A liquid absorber according to a first modified example of the embodiment will now be described with reference to the drawings. FIG. 8 is a schematic plan view of a liquid absorber 200, according to the first modified example of the embodiment. FIG. 9 is a schematic cross-sectional view, taken along line IX-IX of FIG. 8, of the liquid absorber 200 according to the first modified example of the embodiment. Note that, in FIG. 8, the cover 34 and the inlet tube 906 are omitted for convenience.

In the following description, regarding the liquid absorber 200 according to the first modified example of the embodiment, components having a similar function to that of a corresponding structural component of the above-described liquid absorber 100 according to the embodiment are assigned the same reference character, and a detailed description thereof will be omitted. This applies to the descriptions of liquid absorbers of second to fourth modified examples of the embodiment, which will be described later.

In the liquid absorber 100 described above, the first liquid absorption member 10 is disposed on the second liquid absorption member 20, as illustrated in FIG. 1.

In contrast, in the liquid absorber 200, the second liquid absorption member 20 is disposed on the first liquid absorption member 10, as illustrated in FIG. 9. That is, the first liquid absorption member 10 is disposed under the second liquid absorption member 20. In the illustrated example, the second liquid absorption member 20 is disposed between the first liquid absorption member 10 and the cover 34.

In the second liquid absorption member 20, a cavity 22 is disposed at a location corresponding to the inlet 38, as illustrated in FIG. 8 and FIG. 9. That is, in the second liquid absorption member 20, the cavity 22 is disposed at a location where the cavity 22 overlaps the inlet 38 in plan view. In the example illustrated in FIG. 9, the inlet tube 906 is disposed inside the cavity 22. The cavity 22 may be formed by, after storing the second liquid absorption member 20 in the body 32, inserting the inlet tube 906 into the second liquid absorption member 20. Note that, for example, the cavity 22 may be formed in the second liquid absorption member 20 in advance by using a known method, and thereafter the inlet tube 906 may be inserted into the cavity 22.

The inlet tube 906 is disposed in contact with the first liquid absorption member 10. This configuration enables the ink Q to come into contact with the first liquid absorption member 10 before coming into contact with the second liquid absorption member 20.

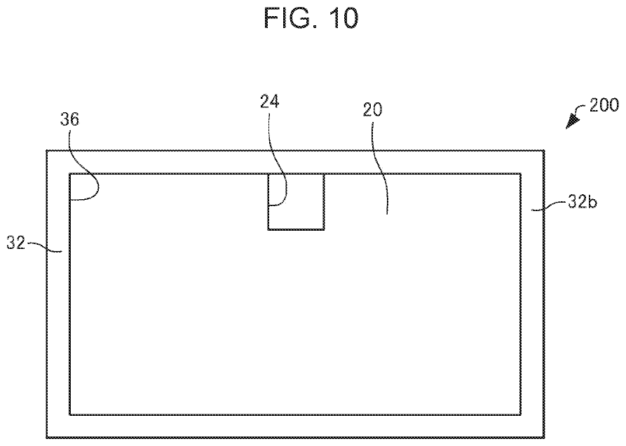

Note that instead of the cavity 22, a cutout 24 may be provided in the second liquid absorption member 20 as illustrated in FIG. 10, depending on the location into which the inlet tube 906 is inserted and a shape of the inlet tube 906, in plan view. As with the cavity 22 described above, the inlet tube 906 can be inserted into the cutout 24, and this configuration enables the ink Q to come into contact with the first liquid absorption member 10 before coming into contact with the second liquid absorption member 20.

### 3. 2. Second Modified Example

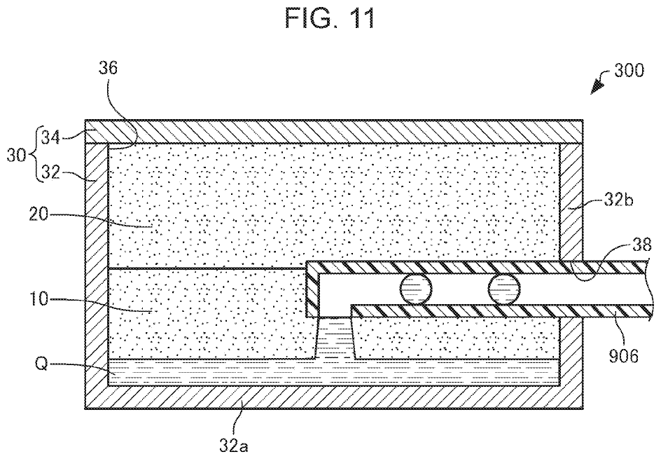

A liquid absorber according to a second modified example of the embodiment will now be described with reference to the drawings. FIG. 11 is a schematic cross-sectional view of a liquid absorber 300, according to the second modified example of the embodiment.

In the liquid absorber 100 described above, the inlet 38 is disposed in the cover 34, as illustrated in FIG. 1.

In contrast, in the liquid absorber 300, the inlet 38 is disposed in the sidewall portion 32b of the body 32, as illustrated in FIG. 11. The inlet 38 is disposed adjacent to a side of the first liquid absorption member 10. The second liquid absorption member 20 is disposed on the first liquid absorption member 10. This configuration enables the ink Q to come into contact with the first liquid absorption member 10 before coming into contact with the second liquid absorption member 20.

### 3. 3. Third Modified Example

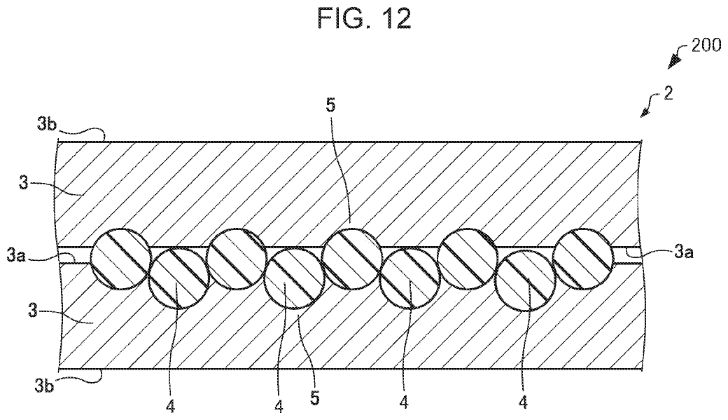

A liquid absorber according to a third modified example of the embodiment will now be described with reference to the drawings. FIG. 12 is a schematic cross-sectional view of a small piece 2 included in a liquid absorber 400, according to a third modified example of the embodiment.

As illustrated in FIG. 12, the liquid absorber 400 is different from the above-described liquid absorber 100 in that the liquid-absorbent resin 4 is held between a pair of the fiber substrates 3.

In the liquid absorber 400, the liquid-absorbent resin 4 is held between a pair of the fiber substrates 3, and, therefore, the liquid-absorbent resin 4 is unlikely to fall off the fiber substrates 3 compared with a configuration in which the liquid-absorbent resin 4 is not held between fiber substrates 3. Accordingly, excellent absorption characteristics with respect to the ink Q are exhibited over a long period of time. In addition, uneven distribution of the liquid-absorbent resin 4 in the case 30 is prevented, and, therefore, variations in absorption characteristics with respect to the ink Q are prevented from occurring.

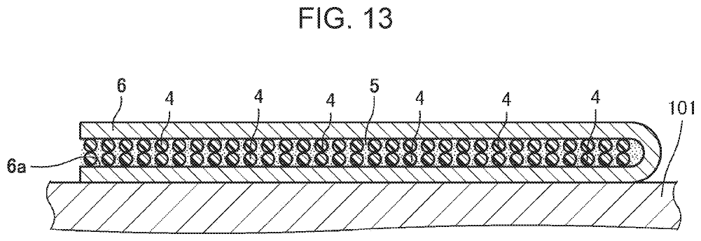

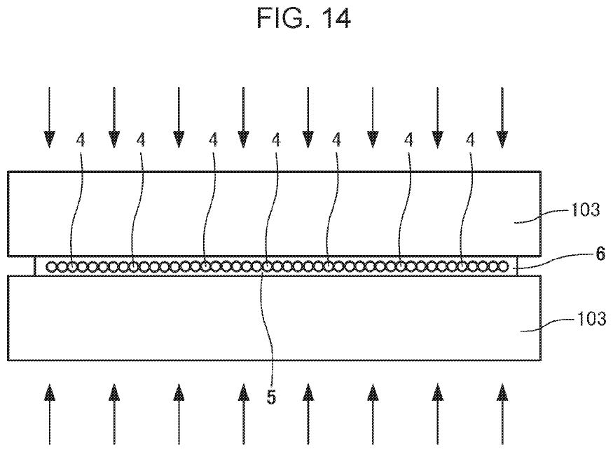

A method for producing the liquid absorber 400, according to the third modified example of the embodiment, will now be described with reference to the drawings. FIG. 13 and FIG. 14 are diagrams illustrating the method for producing the liquid absorber 400, according to the third modified example of the embodiment.

As illustrated in FIG. 13, particles of the liquid-absorbent resin 4 are applied to the sheet member 6 laid on the bench 101, and thereafter, the sheet member 6 is folded in a manner such that the surface 6a, which includes the applied particles of the liquid-absorbent resin 4, is located on the inner side.

As illustrated in FIG. 14, the folded sheet member 6 is positioned between the pair of heating blocks 103. Subsequently, the pair of heating blocks 103 is heated, and pressure is applied to the pair of heating blocks 103 in a direction in which a distance between the heating blocks 103 decreases, thereby applying pressure to the sheet member 6 in a thickness direction thereof. Accordingly, the particles of the liquid-absorbent resin 4 and the adhesive 5 are softened by the heat, and the particles of the liquid-absorbent resin 4 become embedded in the sheet member 6 as a result of the application of pressure. Furthermore, the particles of the liquid-absorbent resin 4 that come into contact with one another as a result of the folding are softened and joined together.

Subsequently, the heating and pressure application are discontinued, and, accordingly, the adhesive 5 dries, and bonding is accomplished in a state in which the particles of the liquid-absorbent resin 4 are embedded in the sheet member 6, and further, the folded halves of the sheet member 6, which overlap each other, are joined together with the particles of the liquid-absorbent resin 4 and the adhesive 5.

Next, the sheet member 6 is cut in a shredder or the like. The subsequent steps are basically the same as those of the method for producing the liquid absorber 100 described above.

In the method for producing the liquid absorber 400, the configuration including multilayers of the sheet member 6 is realized by the simple process, that is, by applying the liquid-absorbent resin 4 to a single sheet member 6 and folding the sheet member 6. That is, there is no need for the operation of applying the liquid-absorbent resin 4 to two sheet members 6 separately. Accordingly, the production process is simplified.

In addition, in the sheet member 6, the surface free of the liquid-absorbent resin 4 comes into contact with the heating blocks 103. Accordingly, adhering of the liquid-absorbent resin 4 to the heating blocks 103 is prevented. Hence, there is no need for a step of cleaning the heating blocks 103.

Note that in the examples described above, the first liquid absorption member 10 and the second liquid absorption member 20 are formed of the small pieces 2. Alternatively, one or both of the liquid absorption members 10 and 20 may be a porous body provided that the penetration property of the first liquid absorption member 10 with respect to, the ink Q is greater than the penetration property of the second liquid absorption member 20 with respect to the ink Q, and the absorption rate of the second liquid absorption member 20 with respect to the ink Q is greater than the absorption rate of the first liquid absorption member 10 with respect to the ink Q. The porous body may be a sponge. Examples of a material of the porous body include polyethylene terephthalate and polyurethane. The liquid absorption members 10 and 20 may include small pieces of a porous body. The small pieces may be formed by cutting the porous body. The small pieces may have a rectangular parallelepiped or cubic shape. When the shape of the small pieces is a rectangular parallelepiped or cubic shape, a length of a side thereof may be 1 mm or greater and 30 mm or less and preferably 5 mm or greater and 20 mm or less, for example.

For example, in a configuration in which an upper liquid absorption member is formed of the small pieces 2, the cover 34 may be lifted up when the liquid-absorbent resin 4 has swollen; this problem can be avoided when the upper liquid absorption member is a porous body.

The first liquid absorption member 10 may be formed of the small pieces 2, and the second liquid absorption member 20 may be a porous body, provided that the penetration property of the first liquid absorption member 10 with respect to the ink Q is greater than the penetration property of the second liquid absorption member 20 with respect to the ink Q, and the absorption rate of the second liquid absorption member 20 with respect to the ink Q is greater than the absorption rate of the first liquid absorption member 10 with respect to the ink Q.

### 3. 4. Fourth Modified Example

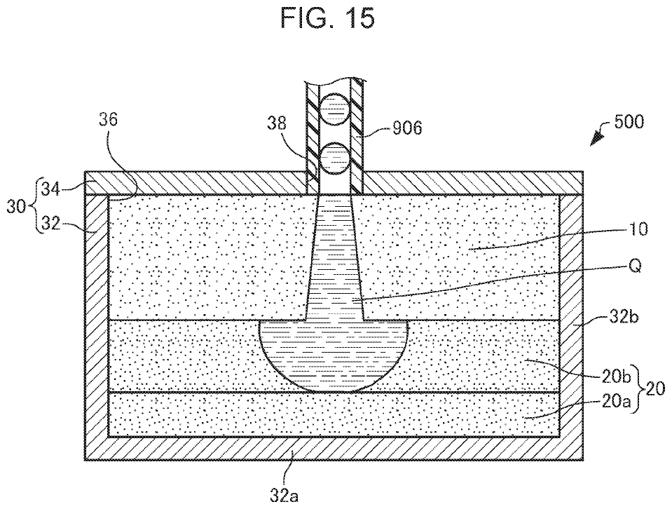

A liquid absorber according to a fourth modified example of the embodiment will now be described with reference to the drawings. FIG. 15 is a schematic cross-sectional view of a liquid absorber 500, according to the fourth modified example of the embodiment.

As illustrated in FIG. 15, the liquid absorber 500 is different from the above-described liquid absorber 100 in that the second liquid absorption member 20 includes a first portion 20a and a second portion 20b.

The first portion 20a is formed of the small pieces 2. The second portion 20b is formed of a porous body. The second portion 20b is disposed on the first portion 20a. In the liquid absorber 500, even when, for example, vibrations are applied from the outside, the second portion 20b formed of a porous body inhibits entry of the small pieces 2 of the first portion 20a into the first liquid absorption member 10 and, therefore, inhibits mixing of the second liquid absorption member 20 with the first liquid absorption member 10.

The penetration property of the first liquid absorption member 10 with respect to the ink Q is greater than the penetration properties of the first portion 20a and the second portion 20b with respect to the ink Q. The absorption rates of the first portion 20a and the second portion 20b with respect to the ink Q are greater than the absorption rate of the first liquid absorption member 10 with respect to the ink Q.

### 4. Liquid Ejection Apparatus

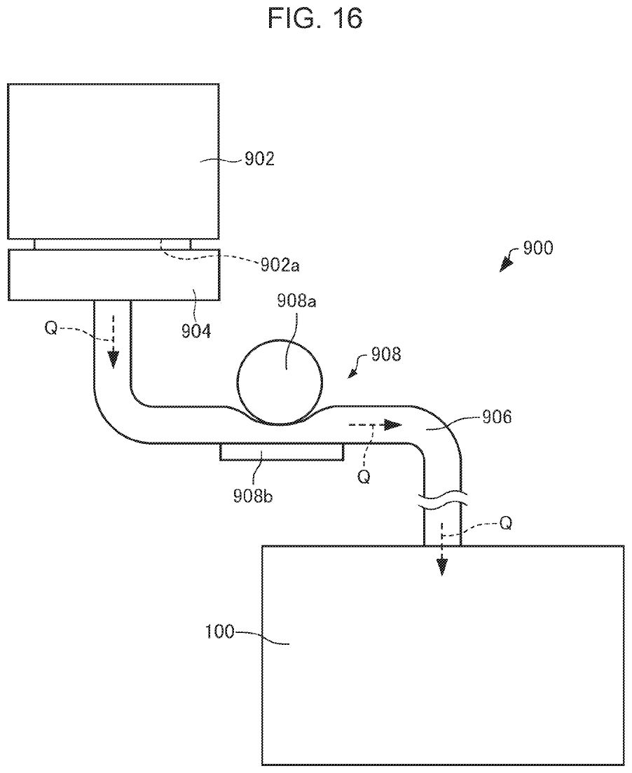

A liquid ejection apparatus according to an embodiment of the present disclosure will now be described with reference to the drawings. FIG. 16 is a schematic diagram of a liquid ejection apparatus 900, according to an embodiment of the present disclosure.

As illustrated in FIG. 16, the liquid ejection apparatus 900 includes, for example, a liquid ejection head 902, a capping unit 904, the inlet tube 906, a roller pump 908, and the liquid absorber 100. The liquid ejection head 902 ejects the ink Q. The capping unit 904 prevents clogging of nozzles 902a of the liquid ejection head 902. The inlet tube 906 couples the capping unit 904 to the liquid absorber 100. The roller pump 908 delivers the ink Q from the capping unit 904. The liquid absorber 100 collects waste liquid of the ink Q.

The liquid ejection head 902 includes the nozzles 902a, through which the ink Q is ejected downwardly. The liquid ejection head 902 can perform printing on a recording medium (not illustrated), such as PPC (plain paper copier) paper, by moving relative to the recording medium and ejecting the ink Q onto the recording medium.

The capping unit 904 prevents clogging of the nozzles 902a in a manner such that when the liquid ejection head 902 is in standby position, the roller pump 908 is actuated to cause the capping unit 904 to apply suction collectively to the nozzles 902a.

The inlet tube 906 allows the ink Q, which is sucked through the capping unit 904, to pass through the inlet tube 906 to the liquid absorber 100. The inlet tube 906 may have flexibility, for example.

The roller pump 908 is located at a portion along the inlet tube 906. The roller pump 908 includes a roller member 908a and a holder member 908b, which holds the portion of the inlet tube 906 with the roller member 908a. Rotation of the roller member 908a generates a suction force in the capping unit 904 via the inlet tube 906. Further, continuous rotation of the roller member 908a enables the ink Q adhering to the nozzles 902a to be delivered to the liquid absorber 100. The ink Q is delivered to the liquid absorber 100 and absorbed as a waste liquid.

The liquid absorber 100 is attachably and detachably mounted to the liquid ejection apparatus 900. In a state in which the liquid absorber 100 is mounted to the liquid ejection apparatus 900, the liquid absorber 100 absorbs the ink Q, which is ejected from the liquid ejection head 902. The liquid absorber 100 is a so-called waste liquid tank. When the amount of absorbed ink Q in the liquid absorber 100 has reached a limit, the liquid absorber 100 can be replaced with a new, unused liquid absorber 100.

Note that whether the amount of absorbed ink Q in the liquid absorber 100 has reached a limit may be detected by a detector (not illustrated) of the liquid ejection apparatus 900. Furthermore, when the amount of absorbed ink Q in the liquid absorber 100 has reached a limit, a notification of the fact may be made by a notification unit, which may be, for example, a built-in monitor of the liquid ejection apparatus 900.

### 5. Examples and Comparative Examples

### 5. 1. Preparation of Samples

### 5. 1. 1. Example 1

Water was applied to PPC paper G80 (A4 size, 4 g), manufactured by Toppan Forms Co., Ltd. Next, 3 g of a liquid-absorbent resin was applied to the PPC paper. The liquid-absorbent resin was Sanfresh ST-500MPSA, manufactured by Sanyo Chemical Industries, Ltd. The PPC paper was then folded in half in a manner such that the liquid-absorbent resin was located on the inner side. The resultant was dried in a heated press under the following conditions: 0.3 kg/cm², 100° C., and 2 minutes.

The dried PPC paper was passed through a shredder to prepare shredded pieces having an average size of 1 mm×10 mm. The shredded pieces were placed in a container to form a lower liquid absorption member.

In addition, the dried PPC paper was passed through the shredder to prepare shredded pieces having an average size of 2 m×25 mm. The shredded pieces were placed on the lower liquid absorption member to form an upper liquid absorption member. Thus, the liquid absorption members were configured such that ink came into contact with the upper liquid absorption member before coming into contact with the lower liquid absorption member, as illustrated in FIG. 1.

### 5. 1. 2. Example 2

Example 2 was similar to Example 1, described above, except that the lower liquid absorption member was a porous body. As the porous body, Fujilon 5000, manufactured by Fujiworld, was used. Fujilon 5000 was cut into sheets such that the sheets could be stored in a case, and then three of the sheets were stacked to form a lower liquid absorption member.

### 5. 1. 3. Example 3

Example 3 was similar to Example 1, described above, except that the lower liquid absorption member was formed of shredded pieces having an average size of 3 m×3 mm. Specifically, the dried PPC paper was passed through the shredder three times to prepare the shredded pieces having an average size of 3 m×3 mm.

### 5. 1. 4. Example 4

Example 4 was similar to Example 1, described above, except that the lower liquid absorption member was formed to include a first portion and a second portion; the first portion was made of a porous body that was the same as the porous body of Example 2, and the second portion was made of shredded pieces that were the same as the shredded pieces of Example 3. The second portion was placed on the first portion.

### 5. 1. 5. Example 5

In Example 5, the lower liquid absorption member was formed of shredded pieces having an average size of 2 mm×25 mm. In addition, the upper liquid absorption member was formed of a porous body that was the same as the porous body of Example 2. Further, a cavity was formed in the upper liquid absorption member. Example 5 was similar to Example 1, described above, except for the differences just described. Thus, the liquid absorption members were configured such that ink came into contact with the lower liquid absorption member before coming into contact with the upper liquid absorption member, as illustrated in FIG. 9.

### 5. 1. 6. Example 6

Example 6 was similar to Example 5, described above, except that the lower liquid absorption member contained no liquid-absorbent resin.

### 5, 1. 7. Comparative Example 1

Comparative Example 1 was similar to Example 1, described above, except that liquid absorption members were formed only of shredded pieces having an average size of 2 m×15 mm. That is, in Comparative Example 1, both the upper liquid absorption member and the lower liquid absorption member were formed of shredded pieces having an average size of 2 m×15 mm. Specifically, the dried PPC paper was passed through the shredder three times to prepare the shredded pieces having an average size of 2 m×15 mm.

### 5. 1. 8. Comparative Example 2

Comparative Example 2 was similar to Example 1, described above, except that liquid absorption members were formed only of shredded pieces having an average size of 2 m×25 mm. That is, in Comparative Example 2, both the upper liquid absorption member and the lower liquid absorption member were formed of shredded pieces having an average size of 2 m×25 mm.

### 5. 1. 9. Comparative Example 3

Comparative Example 3 was similar to Example 5, described above, except that the upper liquid absorption member was formed without a cavity. Thus, the liquid absorption members were configured such that ink came into contact with the upper liquid absorption member before coming into contact with the lower liquid absorption member.

### 5. 2. Evaluation Method

### 5. 2. 1. First Evaluation

In the samples of Examples 1 to 6 and Comparative Examples 1 to 3, which were prepared as described above, an absorption rate of each of the lower liquid absorption members and the upper liquid absorption members with respect to an ink was evaluated.

A container in which 20 cc of the lower liquid absorption member or 20 cc of the upper liquid absorption member was stored was dropped from a height of 10 mm 20 times. Thus, vibrations were applied to the container. Next, ink was added dropwise with a syringe at a rate of 5 cc/5 sec. The ink used was an ink in which pigment inks ICBK61, ICC62, ICM62, and ICY62, manufactured by Seiko Epson Corporation, were mixed at a mixing volume ratio of 3:1:1:1. Next, the container in which the lower liquid absorption member or the upper liquid absorption member was stored was turned on its side (inverted), and evaluation was made by determining the time that elapsed before the ink started leaking out of the container (liquid leakage occurred).

The evaluation criteria for the absorption rates of the lower liquid absorption member and the upper liquid absorption member with respect to the ink are as follows. “A” indicates the highest level of absorption rates, and “D” indicates the lowest level of absorption rates.

A: No liquid leakage occurred.

B: Liquid leakage occurred in less than 2 minutes immediately after the inversion.

C: Liquid leakage occurred in 2 minutes or more and less than 5 minutes.

D: Unabsorbed ink was observed when 5 minutes had passed.

### 5. 2. 2. Second Evaluation

In the samples of Examples 1 to 6 and Comparative Examples 1 to 3, which were prepared as described above, a state of reaching of ink at the bottom surface of the container was evaluated.

A container in which 20 cc of the lower liquid absorption member and 20 cc of the upper liquid absorption member were stored was dropped from a height of 10 mm 20 times. Thus, vibrations were applied to the container. Next, ink was added dropwise with a syringe at a rate of 5 cc/5 sec. The ink was the same as the ink used in the first evaluation.

The evaluation criteria for the state of reaching of ink at the bottom surface of the container are as follows. “A” indicates the highest level of penetration properties of liquid absorption members, and “C” indicates the lowest level of penetration properties of liquid absorption members.

A: The ink reached the entire bottom surface of the container.

B: The ink reached a portion of the bottom surface of the container.

C: The ink did not reach the bottom surface of the container.

### 5. 2. 3. Third Evaluation

In the samples of Examples 1 to 6 and Comparative Examples 1 to 3, which were prepared as described above, an amount of ink leakage was evaluated as a state of liquid leakage associated with an instance in which the container was turned on its side.

A container in which 20 cc of the lower liquid absorption member and 20 cc of the upper liquid absorption member were stored was dropped from a height of 10 mm 20 times. Thus, vibrations were applied to the container. Next, ink was added dropwise with a syringe at a rate of 10 cc/2 sec, and then the resultant was allowed to stand for 2 minutes. Subsequently, the ink was further added dropwise at a rate of 5 cc/1 sec, and immediately after the dropwise addition, the container was turned on its side. The ink was the same as the ink used in the first evaluation.

The evaluation criteria for the state of liquid leakage are as follows.

A: No liquid leakage occurred.

B: Less than 2 cc of liquid leakage occurred.

C: The container was turned before the ink reached the bottom surface of the container; consequently, the ink that had not reached the bottom surface leaked out.

D: The ink reached the bottom surface of the container; however, ink leakage occurred due to a slow absorption rate of a liquid absorption member.

### 5. 3. Evaluation Results

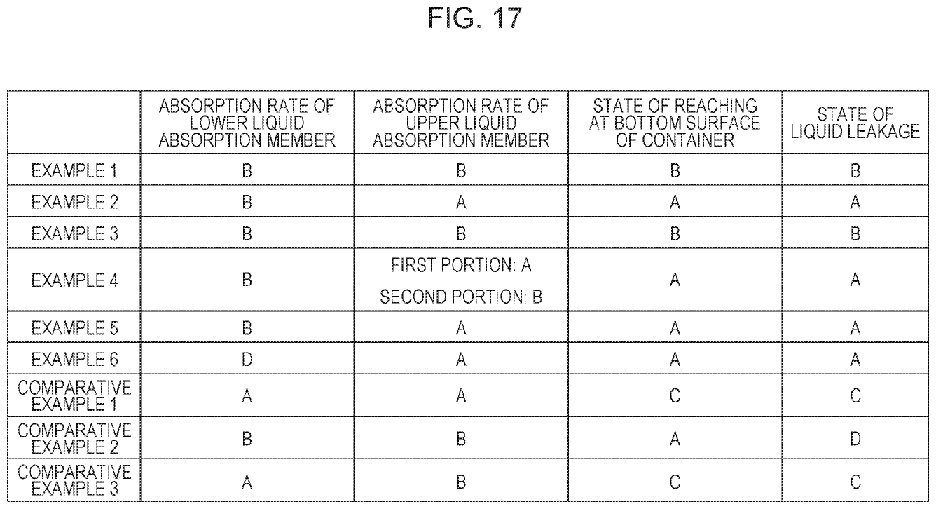

FIG. 17 is a table showing the evaluation results. Note that in FIG. 17, in Example 1, both the absorption rate of the lower liquid absorption member and the absorption rate of the upper liquid absorption member were rated as “B”; however, since the lower liquid absorption member had a smaller area and a higher bulk density than the upper liquid absorption member, the absorption rate of the lower liquid absorption member was greater than the absorption rate of the upper liquid absorption member. The same applies to Example 3.

In Examples 1 to 6, the bulk density of the liquid absorption member (first liquid absorption member), which was configured to come into contact with ink first, was less than the bulk density of the liquid absorption member (second liquid absorption member), which was configured to come into contact with the ink later than did the first liquid absorption member. Accordingly, the absorption rate of the second liquid absorption member with respect to the ink was greater than the absorption rate of the first liquid absorption member with respect to the ink. In contrast, in Comparative Examples 1 to 3, the absorption rate of the second liquid absorption member with respect to the ink was equal to or less than the absorption rate of the first liquid absorption member with respect to the ink.

In addition, in Examples 1 to 6, the penetration property of the first liquid absorption member with respect to the ink was greater than the penetration property of the second liquid absorption member with respect to the ink. In contrast, in Comparative Examples 1 to 3, the penetration property of the first liquid absorption member with respect to the ink was equal to or less than the penetration property of the second liquid absorption member with respect to the ink.

As shown in FIG. 17, regarding the state of liquid leakage, Examples 1 to 6 had better ratings than Comparative Examples 1 to 3.

In Comparative Example 1 and Comparative Example 3, the absorption rates of the lower liquid absorption member and the upper liquid absorption member were high, but the penetration properties with respect to the ink were low; consequently, the ink did not reach the bottom surface of the container. As a result, the rating for the state of liquid leakage was “C”.

In Comparative Example 2, the penetration property with respect to the ink was good, and, therefore, the ink reached the bottom surface of the container; however, since the absorption rates of the lower liquid absorption member and the upper liquid absorption member were low, the ink was not sufficiently absorbed. As a result, the rating for the state of liquid leakage was “D”.

FIG. 17 demonstrates that the amount of liquid leakage can be reduced when the penetration property of the first liquid absorption member with respect to ink is greater than the penetration property of the second liquid absorption member with respect to the ink, and the absorption rate of the second liquid absorption member with respect to the ink is greater than the absorption rate of the first liquid absorption member with respect to the ink.

In the present disclosure, one or more elements may be omitted, and various embodiments and/or modified examples may be combined together, as long as the features and effects described in the present application are retained.

The present disclosure is not limited to the embodiments described above, and various other modifications may be made. For example, the present disclosure includes configurations substantially identical with the configurations described in the embodiments. The substantially identical configurations are, for example, configurations in which functions, methods, and results are identical or configurations in which objects and effects are identical. Furthermore, the present disclosure includes configurations in which one or more non-essential elements of the configurations described in the embodiments are replaced with different elements. Furthermore, the present disclosure includes configurations that produce an effect identical with that of the configurations described in the embodiments or configurations that make it possible to achieve an object identical with that of the configurations. Furthermore, the present disclosure includes configurations in which one or more elements of the known art are added to any of the configurations described in the embodiments.

What is claimed is:

1. A liquid absorber comprising:
a first liquid absorption member that absorbs a portion of a liquid;
a second liquid absorption member that absorbs a portion of the liquid; and
a case in which the first liquid absorption member and the second liquid absorption member are stored, wherein
a penetration property of the first liquid absorption member with respect to the liquid is greater than a penetration property of the second liquid absorption member with respect to the liquid,
an absorption rate of the second liquid absorption member with respect to the liquid is greater than an absorption rate of the first liquid absorption member with respect to the liquid, and
when the liquid is introduced into the case, the liquid comes into contact with the first liquid absorption member before coming into contact with the second liquid absorption member.

2. The liquid absorber according to claim 1, wherein a bulk density of the first liquid absorption member is less than a bulk density of the second liquid absorption member.

3. The liquid absorber according to claim 1, wherein the first liquid absorption member and the second liquid absorption member are formed of small pieces, and the small pieces include fiber substrates and a liquid-absorbent resin supported on the fiber substrates.

4. The liquid absorber according to claim 1, wherein
the first liquid absorption member is formed of small pieces, and the small pieces include fiber substrates and a liquid-absorbent resin supported on the fiber substrates, and
the second liquid absorption member is a porous body.

5. The liquid absorber according to claim 1, wherein the first liquid absorption member is a porous body, and the second liquid absorption member is a porous body.

6. The liquid absorber according to claim 1, wherein
the first liquid absorption member is disposed on the second liquid absorption member, and
an inlet through which the liquid is to be introduced into the case is disposed in an upper portion of the case.

7. The liquid absorber according to claim 1, wherein
the second liquid absorption member is disposed on the first liquid absorption member,
an inlet through which the liquid is to be introduced into the case is disposed in an upper portion of the case, and
in the second liquid absorption member, a cutout or a cavity is disposed in a position corresponding to the inlet.

8. The liquid absorber according to claim 1, wherein
the second liquid absorption member is disposed on the first liquid absorption member,
an inlet through which the liquid is to be introduced into the case is disposed in a sidewall portion of the case, and
the inlet is disposed adjacent to a side of the first liquid absorption member.

9. A liquid ejection apparatus comprising:
a liquid ejection head; and
the liquid absorber according to claim 1, the liquid absorber being an absorber that absorbs the liquid, the liquid being ejected from the liquid ejection head.
